(19) United States
(12) Patent Application Publication
(10) Pub. No.: US 2024/0396255 A1
(43) Pub. Date: Nov. 28, 2024

(54) RELIABLE COMPACT RECEPTACLE CONNECTOR

(71) Applicant: Amphenol East Asia Electronic Technology (Shenzhen) Co., Ltd., Shenzhen (CN)

(72) Inventors: Zhimin Qin, Shenzhen (CN); Fei Wu, Shenzhen (CN)

(73) Assignee: Amphenol East Asia Electronic Technology (Shenzhen) Co., Ltd., Shenzhen (CN)

(21) Appl. No.: 18/667,252

(22) Filed: May 17, 2024

(30) Foreign Application Priority Data
May 22, 2023 (CN) 202310579405.4
May 22, 2023 (CN) 202321248411.3

(51) Int. Cl. H01R 13/502; H01R 12/72; H01R 13/02; H01R 13/52; H01R 43/20

(52) U.S. Cl. CPC H01R 13/502; H01R 12/724; H01R 13/02; H01R 13/521; H01R 43/20

(57) ABSTRACT

Reliable compact receptacle connector. A connector includes a terminal assembly with a housing body and a tongue extending from the body. An inner shell surrounds the terminal assembly and has a tail end with inward portions protruding to the body. The tail end of the inner shell also includes arms disposed beyond the terminal assembly and engaging a rear surface of the terminal assembly. Both the inward portions and arms are integrally formed with the inner shell. Such a configuration enables a single inner shell to restrain movement of the terminal assembly under a mating force. An outer shell is disposed outside the inner shell. The inner shell includes outward protrusions that engage a mating end of an outer shell to restrain its movement under a mounting force. A seal made of an adhesive can be shaped and cured when disposed on a rough portion of the inner shell.

### CROSS-REFERENCE TO RELATED APPLICATIONS

This application claims priority to and the benefit of Chinese Patent Application Serial No. 202321248411.3, filed on May 22, 2023. This application also claims priority to and the benefit of Chinese Patent Application Serial No. 202310579405.4, filed on May 22, 2023. The entire contents of these applications are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors so that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB), which is commonly used in computers. The standards have gone through multiple revisions, adapting to the higher performance expected from computers over time. For example, portable electronic devices often include USB Type-C receptacle connectors for various purposes such as charging and/or exchanging data with another electronic device by connecting the USB receptacle connector with a USB plug connector.

Some USB connectors are water resistant. These connectors may include seals that block water from outside the computer enclosure from entering the computer enclosure through the opening left for the connector.

### SUMMARY

Aspects of the present application relate to reliable compact receptacle connectors.

Some embodiments relate to a receptacle connector. The receptacle connector may include a shell surrounding a cavity and a terminal assembly disposed in the cavity. The shell may include a mating end, and a tail end opposite the mating end and comprising a portion protruding into the cavity. The terminal assembly may include a housing comprising a body engaging the body of the shell and a tongue extending from the body in a mating direction; and a plurality of terminals held by the housing, each of the plurality of terminals comprising a mating portion held by the tongue, a tail portion extending out of the housing, and an intermediate portion held in the body.

Optionally, the portion of the tail end of the shell protruding into the cavity comprises a first subportion extending perpendicular to the mating direction; and a second subportion extending parallel to the mating direction so as to engage the body of the housing of the terminal assembly.

Optionally, the portion of the tail end of the shell protruding into the cavity comprises a third subportion extending in an obtuse angle to the mating direction.

Optionally, the body of the housing of the terminal assembly comprises a recessed portion; and the portion of the tail end of the shell protrudes into the recessed portion of the body of the housing of the terminal assembly to engage the body of the housing.

Optionally, the tail end of the shell comprises an arm disposed beyond the housing of the terminal assembly and extend into the cavity so as to abut against a rear surface of the terminal assembly.

Optionally, the tail end of the shell comprises a first portion protrudes into the cavity from an upper wall of the shell; and the shell comprises a second portion protrudes into the cavity from a bottom wall of the shell, the bottom wall facing the upper wall.

Optionally, the tail end of the shell comprises a plurality of arms disposed beyond the housing of the terminal assembly and engaging a rear surface of the terminal assembly; and the plurality of arms are disposed in symmetrical pairs.

Optionally, the mating end of the shell comprises a portion that has a surface roughness higher than that of portions of the shell; and the receptacle connector comprises a sealing member attached to the portion of the mating end of the shell.

Optionally, the portion that has the higher surface roughness extends in the mating direction by a distance in a range of 0.1 mm to 5 mm.

Optionally, the mating end of the shell comprises a flange portion extending around the shell to form a corner portion with the portion that has the higher surface roughness; and the sealing member is disposed at the corner portion.

Optionally, for each of the plurality of terminals, the tail portion comprises a surface extending perpendicular to the mating direction and configured to mount to a surface of a circuit board.

Optionally, the shell is a first shell; the receptacle connector comprises a second shell disposed outside of the first shell; the second shell comprises a mating end and a tail end opposite the mating end and comprising a plurality of legs extending beyond the tail portions of the plurality of terminals and configured to insert into holes of a circuit board; and the mating end of the first shell extend beyond a mating end of the second shell.

Optionally, the shell comprises a dent disposed closer to the mating end than the portion of the tail end; and the portion of the tail end protrude into the cavity deeper than the dent.

Some embodiments relate to a receptacle connector. The receptacle connector may include a terminal assembly comprising a housing comprising a body and a tongue extending from the body in a mating direction, and a plurality of terminals held by the housing, each of the plurality of terminals comprising a mating portion held by the tongue, a tail portion extending out of the housing, and an intermediate portion held in the body; an inner shell enclosing the housing of terminal assembly in a cavity; and an outer shell enclosing a portion of the inner shell. The tail portions of the plurality of terminals may extend out of the cavity of the inner shell. A mating end of the inner shell may extend beyond a mating end of the outer shell. A tail end of the outer shell may comprise a pair of transition portions extending from a side wall and jogging away from each other and an opening between the pair of transition portions. The tail end of the inner shell may be at least partially exposed by the opening between the pair of transition portions of the outer shell.

Optionally, the tail end of the inner shell comprises a portion protruding into the cavity and engaging a recessed portion of the body of the housing of the terminal assembly.

Optionally, the tail end of the inner shell comprises a plurality of arms disposed beyond the housing of the terminal assembly and engaging a rear surface of the terminal assembly.

Optionally, the tail portion of each of the plurality of terminals comprises a surface extending perpendicular to the mating direction and configured to mount to a surface of a circuit board; and each of the pair of transition portions of the outer shell has a leg extending therefrom in a direction opposite to the mating direction and configured to mount into a hole of the circuit board.

Optionally, the inner shell comprises a protrusion engaging the mating end of the outer shell so as to restrain movement of the outer shell in the mating direction.

Some embodiments relate to a method of manufacturing a receptacle connector. The method may include providing a shell surrounding a cavity, the shell having a first end and a second end opposite the second end; providing a terminal assembly comprising a housing having a body and a tongue extending from the body in a first direction, the body comprising a recessed portion; disposing the terminal assembly into the cavity of the shell; and protruding a portion of the second end of the shell into the cavity before or after disposing the terminal assembly such that the portion of the second end of the shell is disposed in the recessed portion of the body of the terminal assembly.

Optionally, the shell is a first shell comprising a plurality of arms disposed beyond the body of the housing of the terminal assembly, and a protrusion extending outwards. The method may comprise bending the plurality of arms such that the plurality of arms abut against a rear surface of the terminal assembly; providing a second shell comprising a mating end and a tail end having a plurality of legs; and sleeving the second shell onto the first shell until the mating end of the second shell engaging the protrusion of the first shell.

Some embodiments relate to a receptacle connector for an electronic device. The receptacle connector may comprise a terminal assembly comprising an insulative housing molded over a plurality of terminals; a inner shell configured to have a hollow cylindrical shape, the inner shell being sleeved on the outside of the terminal assembly; an outer shell arranged on the outer side of the inner shell and the terminal assembly, a mating end of the inner shell extending beyond a mating end of the outer shell in a mating direction in which the receptacle connector is connected with a corresponding plug connector; and a scaling member attached to an outer sidewall of the inner shell extending beyond the mating end of the outer shell, wherein the inner shell comprises a concave portion provided near a tail end of the inner shell and protruding toward an inner side of the inner shell, and the concave portion is integrally formed with the inner shell.

Optionally, the inner shell comprises a plurality of concave portions comprising a first concave portion and a second concave portion provided in pairs; the first concave portion is provided on a first sidewall of the inner shell; the second concave portion is provided on a second sidewall of the inner shell; the second sidewall is opposite to the first sidewall in a vertical direction perpendicular to the mating direction; and the first concave portion and the second concave portion protrude toward each other in the vertical direction and are spaced apart from each other.

Optionally, the first concave portion is provided at a central portion of a tail end of the first sidewall in a horizontal direction perpendicular to both the mating direction and the vertical direction, and the second concave portion is provided at a central portion of a tail end of the second sidewall in the horizontal direction. The first concave portion is formed with a concave portion recessed inward relative to an outer surface of the first sidewall, and the second concave portion is formed with a concave portion recessed inward relative to an outer surface of the second sidewall.

Optionally, the terminal assembly comprises an accommodating member provided near a tail end of an insulative housing; the accommodating member comprises a first accommodating portion mating with a first concave portion and a second accommodating portion mating with a second concave portion; and the first accommodating portion and the second accommodating portion are provided on opposite sides of the accommodating member in the vertical direction. When the receptacle connector is connected with a corresponding plug connector, the first concave portion and the second concave portion contact or are engaged with at least a portion of the mating portion of the plug connector to limit the insertion position of the mating portion of the plug connector.

Optionally, the inner shell comprises overhanging arms provided at a tail end of the inner shell and extending beyond the concave portion in a direction opposite to the mating direction. When the inner shell is assembled with the terminal assembly, the overhanging arms extend at least partially in a direction toward an inner side of the inner shell, in a tail end plane of the inner shell perpendicular to the mating direction, and are engaged with a tail end surface of the insulative housing.

Optionally, the overhanging arms comprise at least a first set of overhanging arms and a second set of overhanging arms; the first set of overhanging arms is provided adjacent to a third sidewall of the inner shell and the second set of overhanging arms is provided adjacent to a fourth sidewall of the inner shell; the fourth sidewall is opposite to the third sidewall in a horizontal direction perpendicular to the mating direction; and the first set of overhanging arms and the second set of overhanging arms are disposed symmetrically about a vertical central axis in a tail end plane of the inner shell.

Optionally, each set of overhanging arms comprises a first overhanging arm and a second overhanging arm provided in pairs; the first overhanging arm comprises a first proximal end integrally connected with a tail end of the inner shell and a first distal end opposite to the first proximal end; the second overhanging arm comprises a second proximal end integrally connected with a tail end of the inner shell and a second distal end opposite to the second proximal end; and the first distal end of the first overhanging arm and the second distal end of the second overhanging arm extend toward a horizontal central axis perpendicular to the vertical central axis in the tail end plane of the inner shell, when the inner shell is assembled with the terminal assembly.

Optionally, the first distal end of the first overhanging arm and the second distal end of the second overhanging arm are disposed symmetrically about the horizontal central axis when the inner shell is assembled with the terminal assembly.

Optionally, a protrusion is provided on an outer surface of an outer sidewall of the inner shell, and the protrusion is provided to be spaced apart from the mating end of the inner shell by a predetermined distance from each other, and to be engaged with the mating end of the outer shell. By providing a protrusion, a relative position of the outer shell with respect to the inner shell is precisely defined so that the mating end of the outer shell is spaced apart from the mating end of the inner shell by a predetermined distance, reducing the risk of an undesired movement of the outer shell relative to the inner shell in the mating direction, thereby improving positioning accuracy and assembling efficiency.

Optionally, the protrusion is formed to have a circular cross-section, an oval cross-section, a triangular cross-section, a square cross-section, or an irregular shape cross-section.

Optionally, the protrusion is formed on an outer surface of a third sidewall and/or a fourth sidewall in the outer sidewall of the inner shell, and the fourth sidewall is opposite to the third sidewall in a horizontal direction perpendicular to the mating direction.

Optionally, the mating end of the outer shell is provided with a concave fitting portion that is snap-fitted with the protrusion of the inner shell.

Optionally, a tail end of the inner shell is provided with an opening to allow at least a portion of the terminals of the terminal assembly, that is connected with the printed circuit board of the electronic device, to be accessible.

Optionally, a rough portion is provided on the outer sidewall of the mating end of the inner shell extending beyond the mating end of the outer shell; and a sealing member is attached to the rough portion of the inner shell, and the rough portion comprises a pattern part formed by at least one of a diagonal pattern, a grid pattern, or a predetermined symbol pattern. Thus, the outer sidewall of the inner shell of the receptacle connector provided with the rough portion has a surface roughness higher than a surface roughness of remaining portions of the inner shell, thereby significantly improving an adhesion force between the scaling member and the rough portion of the inner shell. The sealing member is firmly attached to the inner shell, effectively avoiding the sealing member from falling off, thus significantly improving the waterproof efficiency and extending the service life of the electrical connector.

Optionally, the predetermined symbol pattern comprises at least one of a starlike shape, an H shape, or an X shape.

Optionally, the rough portion has a width in a range of 0.1 mm to 5 mm from the proximal edge of the inner shell in the mating direction on the outer sidewall of the inner shell.

Optionally, the sealing member is an elastically deformable member and the scaling member is configured to elastically deform when the sealing member is in contact with the mounting portion of the electronic device and to form an interference fit with the mounting portion of the electronic device in a direction perpendicular to the mating direction.

Optionally, the sealing member is configured to have an annular shape extending circumferentially and continuously around the mating end of the inner shell, and the sealing member is configured to have an attachment surface forming a positive fit (forming a shape and position fitting) with the mating end of the inner shell.

Optionally, the sealing member may be provided with an angled portion at the mating end along the mating direction, and an inclined outer surface of the angled portion forms an angle of 20 degrees to 40 degrees relative to the mating end surface of the sealing member.

Optionally, there is provided a method of manufacturing a receptacle connector for an electronic device, comprising: providing a terminal assembly comprising an insulative housing molded over a plurality of terminals; providing a inner shell formed into a hollow cylindrical shape; sleeving the inner shell on an outer side of the terminal assembly, such that the inner shell covers at least a part of the terminal assembly; providing an outer shell; attaching the outer shell to an outer side of the inner shell and the terminal assembly, such that a mating end of the inner shell extends beyond a mating end of the outer shell in a mating direction in which the receptacle connector is connected with a corresponding plug connector; and applying an adhesive along a circumferential direction of the inner shell at a portion of an outer sidewall of the mating end of the inner shell extending beyond the mating end of the outer shell, and curing the adhesive to form a sealing member attached to the outer sidewall, wherein the providing the inner shell comprises: providing a concave portion at the tail end of the inner shell, wherein the concave portion is configured to protrude toward the inner side of the inner shell, and the concave portion is integrally formed with the inner shell.

Optionally, the inner shell comprises providing in the inner shell a plurality of concave portions which comprises a first concave portion and a second concave portion arranged in pairs; wherein the first concave portion is provided on a first sidewall of the inner shell; the second concave portion is provided on a second sidewall of the inner shell; the second sidewall is opposite to the first sidewall in a vertical direction perpendicular to a mating direction; and the first concave portion and the second concave portion protrude toward each other in the vertical direction and are spaced apart from each other.

Optionally, the inner shell comprises providing a plurality of overhanging arms at the tail end of the inner shell, and configuring the plurality of overhanging arms to extend beyond the concave portion in a direction opposite to the mating direction; and when the inner shell is not assembled with the terminal assembly, the overhanging arms extend at least partially along a distal circumferential portion of the outer sidewall of the inner shell, and when the inner shell is assembled with the terminal assembly, the overhanging arms are bent from the tail end of the inner shell in a direction toward an inner side of the inner shell, in a tail end plane perpendicular to the mating direction, and the overhanging arms are engaged with a tail end surface of the insulative housing.

Optionally, the inner shell comprises roughening a portion of an outer surface of the inner shell near its mating end by laser engraving processing or electrical discharge processing to form the rough portion; or embossing or knurling a portion of the outer surface of the inner shell near its mating end to form the rough portion.

Optionally, the inner shell comprises providing a protrusion on an outer surface of an outer sidewall of the inner shell, and the protrusion is provided so as to be spaced apart from the mating end of the inner shell by a predetermined distance.

Some embodiments relate to a method of manufacturing a receptacle connector for an electronic device. The method may comprise providing an adhesive forming tool that is matched with the sealing member in terms of a predetermined size and shape; placing in the adhesive forming tool the rough portion to be processed adjacent to the mating end of the inner shell, and applying an adhesive at the rough portion in a circumferential direction of the inner shell, wherein the adhesive is applied in the adhesive forming tool by one of the following: time and pressure type dispensing, piston pump dispensing, and screw metering pump dispensing.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of a receptacle connector, according to some embodiments;

FIG. 2 is an exploded perspective view of the receptacle connector of FIG. 1, according to some embodiments;

FIG. 3 is a bottom, rear perspective view of a inner shell of the receptacle connector of FIG. 1, according to some embodiments;

FIG. 4 is a perspective view of the inner shell of FIG. 3, viewed from another angle;

FIG. 5 is a perspective view of a terminal assembly of the receptacle connector of FIG. 1, according to some embodiments;

FIG. 6 is a top view of the terminal assembly of FIG. 5 disposed in the inner shell of FIG. 3, according to some embodiments;

FIG. 7 is a cross-sectional view of the terminal assembly of FIG. 5 disposed in the inner shell of FIG. 3, taken along a line marked “E-E” in FIG. 6, according to some embodiments;

FIG. 8 is a rear view of the inner shell of FIG. 3, before overhanging arms of the inner shell bent in position, according to some embodiments;

FIG. 9 is a rear view of the inner shell of FIG. 3, after the overhanging arms of the inner shell bent in position, according to some embodiments;

FIG. 10 is a side view of the inner shell of FIG. 3, according to some embodiments;

FIG. 11 is a top view of the inner shell of FIG. 3, according to some embodiments; and

FIG. 12A is a side view of the receptacle connector of FIG. 1, according to some embodiments.

FIG. 12B is a top view of the receptacle connector of FIG. 1, according to some embodiments.

FIG. 12C is a perspective view of receptacle connector of FIG. 1 mounted on a circuit board, according to some embodiments.

### DETAILED DESCRIPTION

The inventors have recognized and appreciated techniques for making reliable compact receptacle connectors. A receptacle connector may be integrated inside a chassis of an electronic device and configured to receive a mating component such as a plug connector to enable the electronic device to connect with other devices. An existing receptacle connector may include multiple separate pieces joined together (e.g., by welding) in order to position the plug connector in the receptacle. These pieces may become loose or even separated due to the forces applied over the cycles of inserting/removing mating components, causing poor contact between the mated components or even malfunction. Further, terminal tail portions are often obscured by a shell that provides board locks, requiring expensive 3D scanning tools to observe the tails. Such tools, for example, may be required for determining coplanarity between the terminal tail portions and a circuit board to which they are mounted.

Techniques described herein enable a compact receptacle connector with a single inner shell capable of reliably positioning a mating component in the receptacle. The inner shell can have features that restrain movement of an outer shell that provides board locks. The outer shell may have openings between board locks through which terminal tail portions may be inspected with less expensive 2D scanning tools. These less expensive tools may be used for determining the coplanarity between the terminal tail portions and a circuit board to which they are mounted.

According to aspects of the present disclosure, a connector may include an inner shell, a terminal assembly disposed in the inner shell, and an outer shell disposed outside the inner shell. The outer shell, for example, may be used to mount to the connector to a printed circuit board. The inner shell may extend into an opening in a wall of a chassis enclosing the printed circuit board. The terminal assembly may include a housing with a body and a tongue extending from the body in a mating direction. Multiple terminals may be held by the housing. Each terminal may include a mating portion held by the tongue, a tail portion extending out of the housing, and an intermediate portion held in the body. The tail portions may include surfaces configured to mount to a surface of a circuit board.

The inner shell may include a mating end surrounding the tongue of the terminal assembly and a tail end opposite the mating end. The tail end may include inward portions protruding to the body of the housing of the terminal assembly so as to restrain movement of the terminal assembly under a mating/unmating force. The tail end may include arms disposed beyond the terminal assembly and engaging a rear surface of the terminal assembly so as to restrain movement of the terminal assembly under a mating/unmating force. Both the inward portions and arms can be integrally formed with the inner shell. For example, the inward portions may be formed by protruding selected portions of the tail end inwardly until deep enough to engage the body of the housing. In some embodiments, the body of the housing may include recessed portions into which the inward portions may be disposed and engage the body so as to provide sufficient force to restrain the movement of the terminal assembly. The arms may be an extended portion of the inner shell and therefore disposed beyond the terminal assembly. The extended portion may be partially separated from a body of the inner shell such as by cutting a line therebetween, with a proximal end connected to the body of the inner shell and a distal end that can move. For example, after disposing the terminal assembly in the inner shell, the arms may be bent to engage a rear surface of the terminal assembly.

The outer shell may include a mating end and a tail end having legs configured to mount to holes of a circuit board. The inner shell may include outward protrusions that engage the mating end of the outer shell to restrain movement of the outer shell under a mounting force. Top and/or bottom sidewalls of the outer shell may have pairs of transition portions jogging away from each other so as to form an opening therebetween. The tail portions of the terminals may at least partially be exposed by the opening, enabling the use of less expensive 2D scanning tools for determining the coplanarity between the terminal tail portions and a circuit board to which they are mounted.

The connector may have a seal made from an adhesive, which may provide more flexibility in locating the seal. The adhesive shaped may be disposed on the rough portion and shaped and cured on the rough portion to form the seal. Alternatively or additionally, the seal may provide improved water resistance. One or more features may be used to provide mechanical integrity to the seal. In some examples, the mating end of the inner shell may have a rough portion. That portion may be processed differently from other portions of the shell such that it has a surface roughness higher than other portions of the shell. Different processing may result from processing steps, preferentially performed on the portion, to roughen the surface. Alternatively or additionally, different processing may result from omitting processing steps that tend to smooth other parts of the shell, such as cold rolling or plating. In some examples, a desired surface roughness for the rough portion may be obtained by using Electrical Discharge Machining (EDM) in a range of 8 to 12. It should be appreciated that larger EDM may lead to higher roughness and better adhesion. In some examples, the rough portion may have patterns to enhance adhesion. These patterns may be visually observable and/or comprise symbols such as *, H, or X, which may be laser imprinted around the mating end of the shell. In some examples, the rough portion may extend in the mating direction by a distance in a range of 0.1 mm to 5 mm such as in a range of 0.5 mm to 1.5 mm.

A seal may be disposed on the rough portion of the mating end of the inner shell such that the seal can be securely attached to the inner shell. In some examples, an adhesive (e.g., UV glue, silicone, epoxy glue, or underfill) may be disposed on the rough portion and shaped and cured on the rough portion to form the seal. The seal can be spaced from the outer shell in the mating direction so as to extend above the outer shell. Such a configuration enables the seal to deform in a direction perpendicular to the mating direction when the connector is pressed, in the mating direction, against a wall with an opening through which the mating face of the connector will be exposed, blocking ingress of environmental contaminants. The seal may also block any path between the mating ends of the inner and outer shells.

Alternatively or additionally, the shell to which the shield is affixed may have a lip forming a corner between the lip and a surface of the shell. The seal may be affixed in this corner. A surface of either or both of the lip or shell in the corner may be roughened for improved adhesion of the seal.

Next, exemplary embodiments of the receptacle connector according to the present application will be described in detail with reference to the accompanying drawings. For a clear and concise description, a mating direction Y, a horizontal direction X and a vertical direction Z may be shown in the figure. The mating direction Y, the horizontal direction X and the vertical direction Z may be perpendicular to one another. The mating direction Y may refer to a direction in which the receptacle connector is to connect with a corresponding plug connector. The horizontal direction X may refer to a width direction of the receptacle connector. The vertical direction Z may refer to a height direction of the receptacle connector.

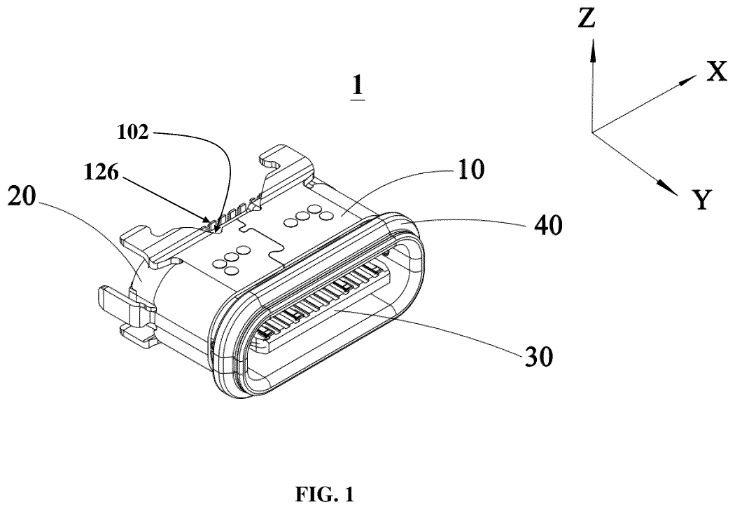

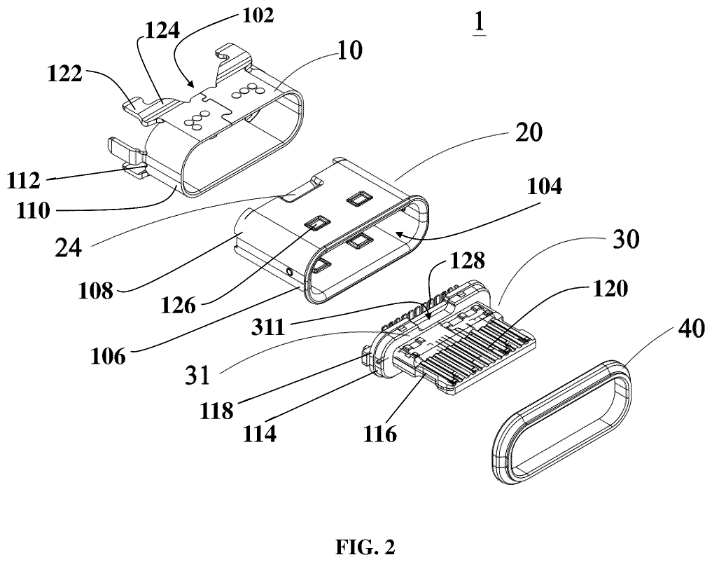

Referring to FIGS. 1 and 2, in an exemplary embodiment, a receptacle connector 1 may include a terminal assembly 30, an inner shell 20, an outer shell 10, and a sealing member 40. The inner shell 20 may have a hollow cylindrical shape. The terminal assembly 30 may include an insulative housing molded over a plurality of terminals. As can be seen in FIGS. 1 and 2, the housing may include a body 114 and a tongue 116 extending from the body in a mating direction (e.g., direction Y). Each terminal may have a mating portion 120 held by the tongue 116, a tail portion 128 extending out of the housing, and an intermediate portion held in the body 114 of the housing. The body 114 of the housing may include a recessed portion 311 (which may also be referred to as an accommodating portion). The terminal assembly may further include a rear seal 118 disposed against the body 114 of the housing.

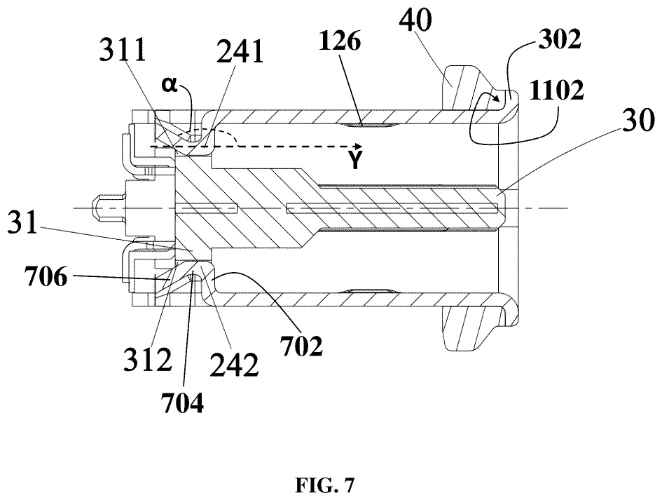

As can be seen in FIGS. 1 and 2, the inner shell 20 may surround a cavity 104. The inner shell 20 may have a mating end 106 and a tail end 108 opposite the mating end 106. The tail end 108 of the inner shell 20 may include a concave portion 24 protruding toward an inner side of the inner shell 20. The concave portion 24 can be integrally formed with the inner shell 20. For example, the concave portion 24 may be formed by protruding a selected portion 14 of the tail end 108 into the cavity 104 such that the selected portion may be disposed in the recessed portion 311 of the body 114 of the housing and/or engage the body 114 of the housing. The inner shell 20 may have a dent 126 disposed closer to the mating end 106 than the concave portion 24. As can be seen in FIG. 7, the concave portion 24 protrudes deeper into the cavity 104 than the dent 126. Such a configuration may enable a single, integral inner shell to restrain the movement of the terminal assembly 30 by a force applied for inserting a mating component.

Referring back to FIGS. 1 and 2, the concave portion 24 protrudes toward the inner side of the inner shell 20. The concave portion 24 can be integrally formed with the inner shell 20. When the receptacle connector 1 and the corresponding plug connector are mated with each other, a position of the mating portion of the plug connector is limited by the concave portion 24, thus precisely controlling the insertion depth of the mating portion and avoiding an over-insertion or insufficient insertion. With the receptacle connector 1 according to the present application, the concave portion 24 is a part of the inner shell 20, and for example, the concave portion 24 is integrally formed with the inner shell 20 from a single blank. As compared with the technical solution in the related art where additional components are needed, the technical solution of the present application reduces the number of components of the receptacle connector 1, and simplifies the structure of the receptacle connector 1 and its manufacturing process, allowing a more compact structure of the receptacle connector while also improving the durability of the receptacle connector. This reduces the risk that the concave portion shifts and/or falls off due to frequent uses, thus the contact stability and the connection reliability of the plug connector and the receptacle connector is improved.

The inner shell 20 can be sleeved on an outer side of the terminal assembly 30. The outer shell 10 may be attached to an outer side of the inner shell 20 and the terminal assembly 30. The mating end 106 of the inner shell 20 may extend beyond a mating end 110 of the outer shell 10 in a mating direction Y in which the receptacle connector is to be connected with a corresponding plug connector. The sealing member 40 may be attached to a portion of an outer sidewall of the inner shell 20 extending beyond the mating end of the outer shell 10.

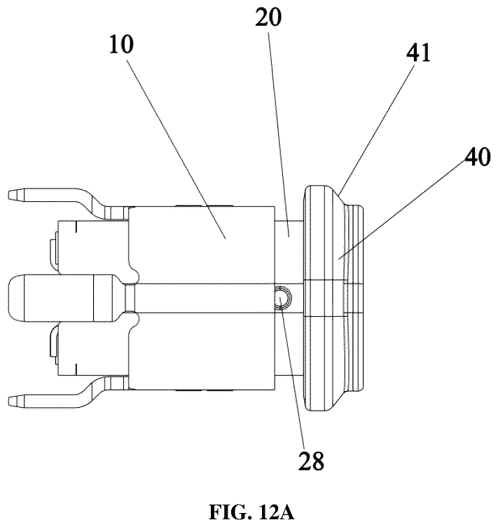

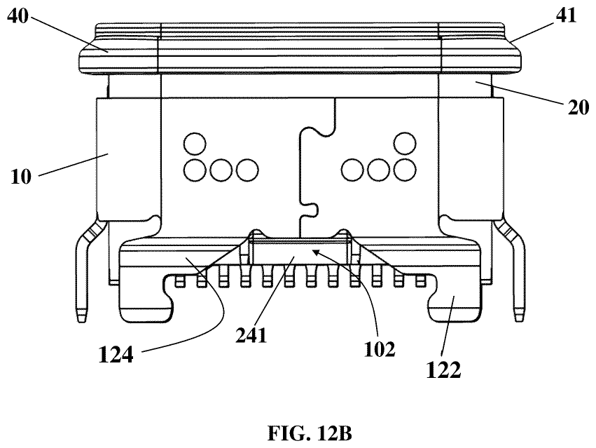

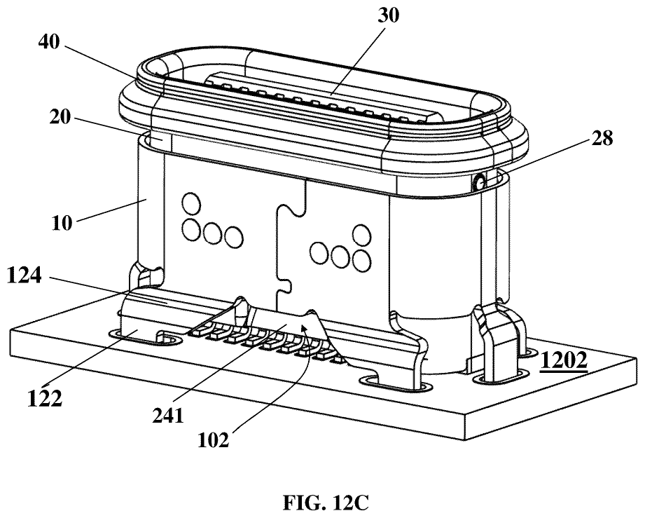

As can be seen in FIGS. 1 and 2, the outer shell 10 may include the mating end 110 and a tail end 112 opposite the mating end 110. The tail end 112 of the outer shell 10 may include legs 122 configured to insert into holes of a circuit board 1202 so as to hold the connector on the circuit board (see also FIG. 12C). Each of sidewalls 21 and 23 may include a pair of transition portions 124 jog away from each other and form an opening 102 therebetween such that the tail end 108 of the inner shell 20 is at least partially exposed by the opening 102 (see also FIG. 12B).

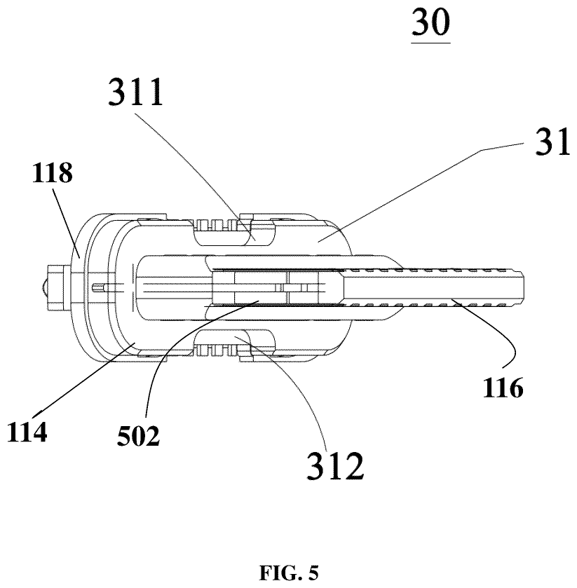

The inner shell 20 and the outer shell 30 may be metal housings made of metal materials (e.g., iron, aluminum, and alloys thereof). Optionally, the inner shell 20 and the outer shell 30 may be made of iron. In some embodiments, conductive terminals 30 may comprise at least two rows of conductive terminals. The terminal assembly 30 further comprises a shield (e.g., shield 502 as can be seen in FIG. 5) located between the conductive terminals, and the shield is configured to shield a signal interference between two rows of conductive terminals.

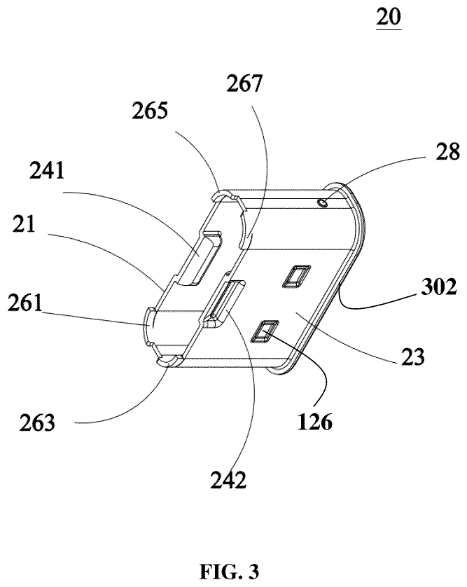

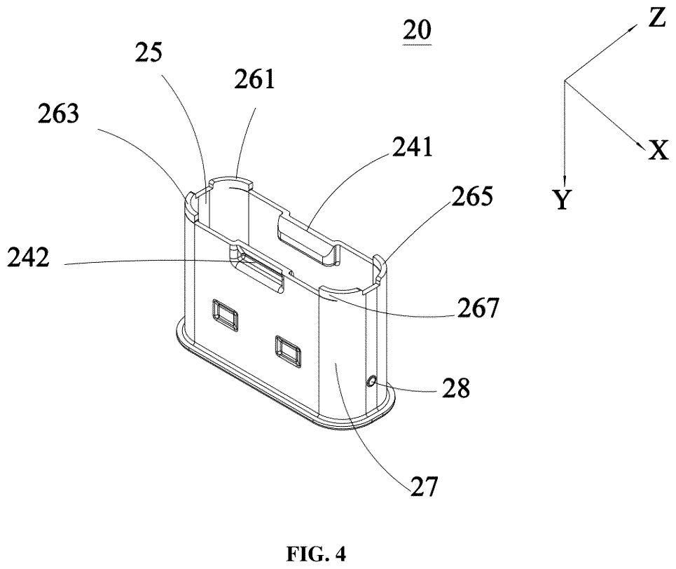

As shown in FIGS. 3 and 4, the inner shell 20 may comprise a plurality of concave portions 24, which comprise a first concave portion 241 and a second concave portion 242 provided in pairs. The first concave portion 241 is provided on a first sidewall 21 of the inner shell 20; and the second concave portion 242 is provided on a second sidewall 23 of the inner shell 20. The second sidewall 23 is opposite to the first sidewall 21 in a vertical direction Z perpendicular to a mating direction Y; and the first concave portion 241 and the second concave portion 242 protrude toward each other in the vertical direction Z and are spaced apart from each other. It should be understood that the first concave portion 241 may be integrally formed with the first sidewall 21 at an outer surface on the first sidewall 21 of the inner shell 20, and the second concave portion 242 may be integrally formed with the second sidewall 23 at an outer surface of the second sidewall 23 of the inner shell 20. The size, number and arrangement position of the plurality of concave portions may be adjusted upon actual assembling requirements. For example, the number of concave portions is not limited to two, and four, six or eight concave portions may be provided on the inner shell 20.

In some exemplary embodiments, the first concave portion 241 may be formed from the first sidewall 21 of the inner shell 20 by stamping and drawing. The second concave portion 242 may be formed from the second sidewall 23 of the inner shell 20 by stamping and drawing. Such a configuration enables the first and second concave portions 241, 242 to be an integral part of the inner shell 20.

In one example, as shown in FIG. 4, the first concave portion 241 is provided at a central portion of a tail end of the first sidewall 21 in a horizontal direction X perpendicular to both the mating direction Y and the vertical direction Z, and the second concave portion 242 is provided at a central portion of a tail end of the second sidewall 23 in a horizontal direction X. The first concave portion 241 is formed with a concave portion recessed inward relative to an outer surface of the first sidewall 21, and the second concave portion 242 is formed with a concave portion recessed inward relative to an outer surface of the second sidewall 23.

In some exemplary embodiments, as shown in FIGS. 5 and 7, the terminal assembly 30 may comprise an accommodating member 31 provided near a tail end of an insulative housing. The accommodating member 31 comprises a first accommodating portion 311 configured to engage a first concave portion 241 and a second accommodating portion 312 configured to engage a second concave portion 242; and the first accommodating portion 311 and the second accommodating portion 312 are provided on opposite sides of the accommodating member 31 in the vertical direction Z. When the receptacle connector is connected with a corresponding plug connector, the first concave portion 241 and the second concave portion 242 is in contact/engagement with at least a portion of the mating portion of the plug connector to limit the insertion position of the mating portion of the plug connector. The insertion depth of the mating portion of the plug connector can be defined by providing sizes and arrangement positions of the accommodating member 31, the first concave portion 241 and the second concave portion 242 in the mating direction. In one example, both the first accommodating portion 311 and the second accommodating portion 312 are provided to have a concave shape. In one example, both the first accommodating portion 311 and the second accommodating portion 312 are formed to have a U-shaped shape in a cross-section perpendicular to the mating direction Y.

As can be seen in FIG. 7, each concave portion 24 may include a first subportion 702 extending perpendicular to the mating direction so as to engage a face of a mating component and restrain the mating component from over insertion. Each concave portion 24 may include a second subportion 704 extending parallel to the mating direction so as to engage the body 114 of the housing of the terminal assembly 30. Each concave portion 24 may further include a third subportion 706 extending in an obtuse angle α to the mating direction.

It should be understood that the arrangement and position of the concave portion may be adjusted according to a predetermined insertion depth and actual assembling requirements. The first concave portion 241 and the second concave portion 242 can be provided at any position of the tail ends of the first sidewall 21 and the second sidewall 23, respectively, provided that the first concave portion 241 and the second concave portion 242 mate with the first accommodating portion 311 and the second accommodating portion 312, respectively, so that the first concave portion 241 and the second concave portion 242 are in contact with at least a portion of the mating portion of the plug connector when the receptacle connector is connected to the corresponding plug connector, thereby stopping the mating portion of the plug connector.

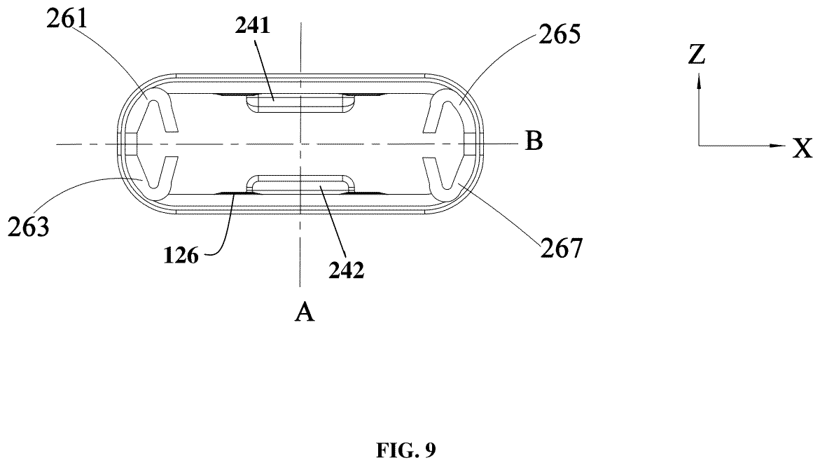

In some exemplary embodiments, as shown in FIGS. 3 and 4, the inner shell 20 comprises overhanging arms 261, 263, 265, 267 provided at a tail end of the inner shell 20 and extending beyond the concave portion 24 in a direction opposite to the mating direction Y. When the inner shell 20 is assembled with the terminal assembly 30, the overhanging arms extend from the tail end of the inner shell 20 in a direction toward an inner side of the inner shell 20, in a tail end plane (X-Y plane) of the inner shell perpendicular to the mating direction Y (as shown in FIG. 9), and are engaged with a tail end surface of the insulative housing.

By providing the overhanging arms at the tail end of the inner shell 20, when the inner shell 20 is assembled with the terminal assembly 30, the overhanging arms 26 are bent from the tail end of the inner shell 20 in a direction toward the inner side of the inner shell, and are engaged with the tail end of the insulative housing to limit a position of the insulative housing. When a user connects the plug connector to the receptacle connector with a large force, the risk that the insulative housing falls out of the tail end of the receptacle connector is reduced.

In some examples, the overhanging arms 261, 263, 265, 267 are integrally formed with the inner shell 20 from a single metal blank. Such a configuration enables overhanging arms 261, 263, 265, 267 to be an integral part of the inner shell 20.

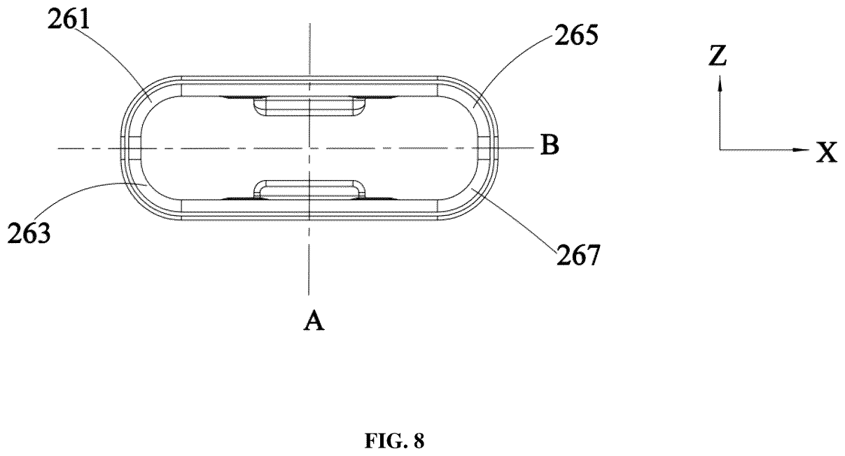

In some exemplary embodiments, as shown in FIG. 4, the overhanging arms comprise at least a first set of overhanging arms 261, 263 and a second set of overhanging arms 265, 267. The first set of overhanging arms 261, 263 is provided adjacent to a third sidewall 25 of the inner shell 20 and the second set of overhanging arms 265, 267 is provided adjacent to a fourth sidewall 27 of the inner shell 20. The fourth sidewall 27 is opposite to the third sidewall 25 in a horizontal direction X perpendicular to the mating direction Y. As shown in FIG. 8, the first set of overhanging arms 261, 263 and the second set of overhanging arms 265, 267 are disposed symmetrically about a vertical central axis A in a tail end plane of the inner shell 20 perpendicular to the mating direction Y. As shown in FIG. 4, in some embodiments, both the third sidewall 25 and the fourth sidewall 27 may be formed to have a curved shape.

In some exemplary embodiments, each set of overhanging arms comprises a first overhanging arm 261 and a second overhanging arm 263 provided in pairs. The first overhanging arm 261 comprises a first proximal end integrally connected with a tail end of the inner shell 20 and a first distal end (e.g., free end) opposite to the first proximal end; and the second overhanging arm 263 comprises a second proximal end integrally connected with a tail end of the inner shell 20 and a second distal end opposite to the second proximal end. The first proximal end are connected with the second proximal end; and the first distal end and the second distal end extend along a distal circumferential portion of the inner shell 20 when the inner shell 20 is not assembled with the terminal assembly 30 (as shown in FIG. 8).

In some examples, the first overhanging arm 261 and the second overhanging arm 263 and the third sidewall 25 of the inner shell 20 may be formed from a single blank, and the first proximal end of the first overhanging arm 261 and the second proximal end of the second overhanging arm 263 are integrally formed with the third sidewall 25 of the inner shell 20. In one example, each of the first overhanging arm 261 and the second overhanging arm 263 has an arcuate shaped cross-section in a plane perpendicular to the mating direction Y (as shown in FIG. 8).

In some exemplary embodiments, as shown in FIG. 9, when the inner shell 20 is assembled with the terminal assembly 30, the first distal end of the first overhanging arm 261 and the second distal end of the second overhanging arm 263 extend toward a horizontal central axis B perpendicular to the vertical central axis A in the tail end plane of the inner shell 20 and are disposed symmetrically about the horizontal central axis B.

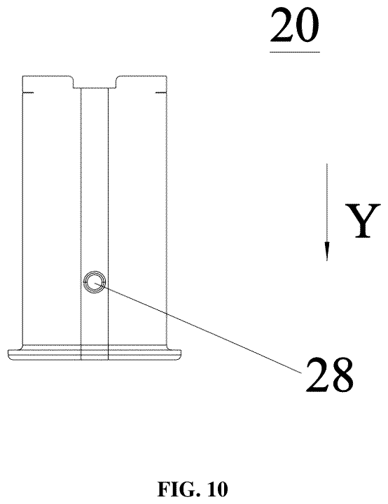

In some exemplary embodiments, as shown in FIGS. 10 and 12A, a protrusion 28 is provided on an outer surface of an outer sidewall of the inner shell 20, and the protrusion 28 is provided so as to be spaced apart from the mating end of the inner shell 20 by a predetermined distance, and to be engaged with the mating end of the outer shell 10. By providing a protrusion 28, a position of the outer shell 10 relative to the inner shell 20 is limited so that the mating end of the outer shell 10 is spaced apart from the mating end of the inner shell 20 by a predetermined distance, thereby reducing the risk of an undesired movement of the outer shell 10 relative to the inner shell 20 along the mating direction Y. Accordingly, the assembling accuracy and reliability are improved.

In some exemplary embodiments, the protrusion 28 is formed to have a circular cross-section, an oval cross-section, a triangular cross-section, a square cross-section, or an irregular shape cross-section.

In some exemplary embodiments, as shown in FIG. 4, the protrusion 28 is formed on an outer surface of a third sidewall 25 and/or a fourth sidewall 27 of an outer sidewall of the inner shell 20, and the fourth sidewall 27 is opposite to the third sidewall 25 in a horizontal direction X perpendicular to the mating direction Y.

In one example, the protrusion 28 of the inner shell 20 may be provided such that a height of the protrusion 28 in the horizontal direction X does not extend beyond an outer surface of the outer shell 10 when the inner shell 20 is assembled with the outer shell 10. The mating end of the outer shell 10 may be provided with a concave fitting portion that is snap-fitted with the protrusion of the inner shell 20.

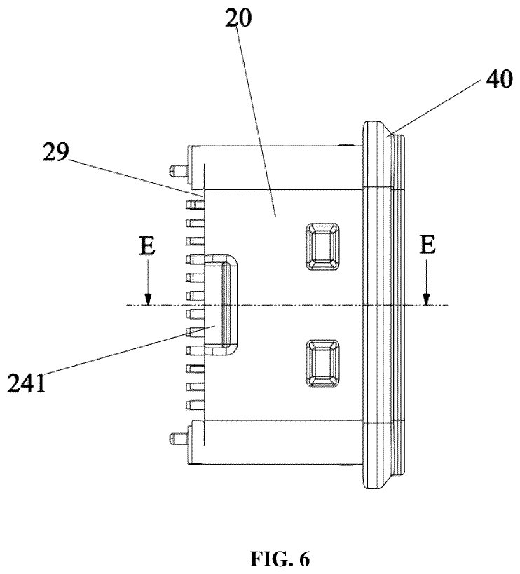

In some exemplary embodiments, as shown in FIG. 6, a tail end of the inner shell 20 is provided with an opening 29, which together with the opening 102 of the outer shell 10 enables at least a portion of the terminals of the terminal assembly 30, that is connected with the printed circuit board of the electronic device, to be accessible. For example, by the provision of the opening 29 and/or the opening 102 of the outer shell 10, a portion of the terminals of tail end of the terminal assembly 30 is exposed, such that, in the process of detecting the coplanarity of the terminal and the connection between the terminal and the printed circuit board, the detecting operation can be facilitated. This reduces the detecting costs, and improves the assembling efficiency of the receptacle connector.

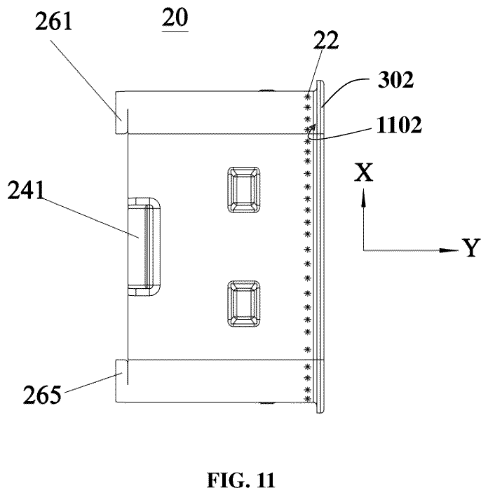

In some exemplary embodiments, as shown in FIG. 11, the mating end 106 of the inner shell 20 may include a rough portion 22 provided on a portion of the outer sidewall of the mating end of the inner shell 20 extending beyond the mating end of the outer shell 10. The rough portion 22 may comprise a pattern formed by at least one of a diagonal pattern, a grid pattern, or a predetermined symbol pattern. For example, the predetermined symbol pattern may comprise at least one of a starlike shape, an H shape, or an X shape. A scaling member 40 may be attached to the rough portion 22 of the inner shell 20 so as to hold onto the inner shell 20 with higher strength.

The mating end 106 of the inner shell 20 may include a flange portion 302 at a distal end and extending around the inner shell 20 to form a corner 1102 with the rough portion 22. The sealing member 40 may be disposed in the corner 1102. The sealing member 40 may block any path between the inner shell 20 and the outer shell 10.

In some embodiments, a rough portion is provided on a portion of an outer sidewall of the mating end of the inner shell extending beyond the mating end of the outer shell; and a sealing member is provided on the rough portion of the inner shell. With the above technical solution, a very close attachment between the sealing member and the inner shell can be provided, and the portion of the outer sidewall of the inner shell of the receptacle connector, that is provided with the rough portion, has a surface roughness higher than a surface roughness of remaining portions of the inner shell, thereby significantly improving an adhesion force between the sealing member and the rough portion of the inner shell. Accordingly, the risk that the sealing member falls off is reduced. Therefore, a seamless seal can be generated between the receptacle connector and the mounting portion of the electronic device when the receptacle connector is mounted to the mounting portion of the electronic device, so as to reduce the risk that water vapor/dust enters inside of the electronic device.

The rough portion 22 has a width in a range of 0.1 mm to 5 mm from the proximal edge of the inner shell 20 in the mating direction Y on the outer sidewall of the inner shell 20. In some embodiments, the rough portion 22 has a width in a range of 0.5 mm to 3 mm from the proximal edge of the inner shell 20 in the mating direction Y on the outer sidewall of the inner shell 20. In some embodiments, the rough portion 22 has a width in a range of 0.5 mm to 1.5 mm from the proximal edge of the inner shell 20 in the mating direction Y on the outer sidewall of the inner shell 20.

In some embodiments, a surface roughness of the rough portion 22 of the inner shell may be in the range of EDM 8-12.

The seaming member 40 may be an elastically deformable member. The sealing member 40 is configured to elastically deform when the sealing member 40 is in contact with the mounting portion of the electronic device (for example, a portion of the shell of the electronic device) and to form an interference fit with the mounting portion of the electronic device in a direction perpendicular to the mating direction Y. In one example, the sealing member may be made of ultraviolet light-curable adhesive (UV adhesive), silicone, or epoxy resin adhesive. Ultraviolet light-curable adhesive is rapidly cured into an elastic adhesive film under UV light irradiation, and is characterized by high adhesive strength, vibration resistance, high temperature resistance, and good durability, etc.

The sealing member 40 has a width in the range of 0.1 mm to 5 mm in the mating direction Y. In some optional embodiments according to the present application, the sealing member 40 may have a width of 0.95 mm in the mating direction Y. Preferably, the scaling member 40 may have a width of 1.0 mm in the mating direction Y.

In an exemplary embodiment, the sealing member 40 is configured to have an annular shape extending circumferentially and continuously around the mating end of the inner shell 20, and the sealing member 40 is configured to have an attachment surface forming a shape and position fitting with the mating end of the inner shell 20. The sealing member 40 may be provided with an angled portion 41 at the mating end along the mating direction, and an inclined outer surface of the angled portion 41 forms an angle of 20 degrees to 40 degrees relative to the mating end surface of the sealing member.

It should be understood that the term “a shape and position fitting (a positive fit)” used in the present application may refer to a relationship in which two mating components are abutting and tightly fitted with each other in terms of the shape and the position.

The present application provides a method of manufacturing a receptacle connector for an electronic device. In some exemplary embodiments, a method of manufacturing a receptacle connector for an electronic device may include providing a terminal assembly 30 comprising an insulative housing molded over a plurality of terminals; providing an inner shell 20 formed into a hollow cylindrical shape; sleeving the inner shell 20 on an outer side of the terminal assembly 30, such that the inner shell 20 covers at least a part of the terminal assembly 30; providing an outer shell 10; attaching the outer shell 10 to an outer side of the inner shell 20 and the terminal assembly 30, such that a mating end of the inner shell 20 extends beyond a mating end of the outer shell 10 in a mating direction Y along which the receptacle connector 1 is connected with a corresponding plug connector; and applying an adhesive along a circumferential direction of the inner shell 20 at a portion of an outer sidewall of the mating end of the inner shell 20 extending beyond the mating end of the outer shell 10, and curing the adhesive to form a sealing member 40 attached to the outer sidewall. The step of providing the inner shell comprises: providing a concave portion 24 at the tail end of the inner shell 20, and configuring the concave portion 24 to protrude toward the inner side of the inner shell 20.

In some examples, the concave portion 24 is integrally formed with the inner shell 20, and the concave portion 24 is formed at the tail end of the inner shell 20 by a stamping process, such as by stamping and drawing. It should be understood that stamping process is a production technology in which, with the help of stamping equipment (presses) and tools (dies), pressure is exerted on panel metal or non-metal to allow the panel metal or non-metal to have separation or plastic deformation, thus obtaining a product with a certain shape, size and performance requirements. “Stamping and drawing” may refer to a stamping process during which a flat plate material is processed into a hollow component by using a stamping die, or further changes the shape and size of the hollow component.

In some exemplary embodiments, the step of providing the inner shell 20 comprises: forming on the inner shell 20 a plurality of concave portions, which comprise a first concave portion 241 and a second concave portion 242 provided in pairs. The first concave portion 241 is provided on a first sidewall 21 of the inner shell 20; the second concave portion 242 is provided on a second sidewall 23 of the inner shell 20; and the second sidewall 23 is opposite to the first sidewall 21 in a vertical direction Z perpendicular to a mating direction Y. The first concave portion 241 and the second concave portion 242 protrude toward each other in the vertical direction and are spaced apart from each other.

In some exemplary embodiments, the step of providing the inner shell comprises: forming at the tail end of the inner shell 20 a plurality of overhanging arms 261, 263, 265, 267. The plurality of overhanging arms are configured to extend beyond the concave portion 24 in a direction opposite to the mating direction Y. When the inner shell 20 is not assembled with the terminal assembly 30, the overhanging arms 261, 263, 265, 267 extend along a distal circumferential portion of the outer sidewall of the inner shell 20. When the inner shell 20 is assembled with the terminal assembly 30, at least a portion of the overhanging arms 261, 263, 265, 267 is bent at least partially from the tail end of the inner shell 20 in a direction toward an inner side of the inner shell 20, in a tail end plane perpendicular to the mating direction Y, and is engaged with a tail end surface of the insulative housing.

In some examples, the overhanging arms 261, 263, 265, 267 are formed by cutting a prefabricated member of the inner shell 20. For example, the cylindrical-shaped prefabricated member of the inner shell 20 comprises a first sidewall 21, a second sidewall 23 opposite to the first sidewall 21 in the vertical direction Z, a third sidewall 25 connected to the first sidewall 21 and the second sidewall 23, and a fourth sidewall 27 opposite to the third sidewall 25 in the horizontal direction X. The third sidewall 25 has a body portion and a projecting portion extending from the body portion beyond the first sidewall and the second sidewall in a direction opposite to the mating direction Y. The projecting portion of the third sidewall 25 is cut or sheared to form a slit at least partially between the body portion of the third sidewall and the projecting portion, thereby forming the first set of overhanging arms 261, 263. Similarly, the projecting portion of the fourth sidewall is cut to form a slit at least partially between the body portion of the fourth sidewall and the projecting portion, thereby forming the second set of overhanging arms 265, 267.

In some exemplary embodiments, the step of providing the inner shell 20 comprises: forming a protrusion 28 on an outer surface of an outer sidewall of the inner shell 20. The protrusion 28 is configured to be spaced apart from the mating end of the inner shell by a predetermined distance. In one example, the protrusion 28 is formed by stamping and drawing at the outer surface of the outer side wall of the inner shell 20, or the pre-formed protrusion is welded to the outer surface of the outer side wall of the inner shell 20 at a suitable location.

In some exemplary embodiments, the step of providing the inner shell comprises: roughening a portion of an outer surface of the inner shell 20 near its mating end by laser engraving processing (also known as radium welding) or electrical discharge processing to form a rough portion 22; or embossing or knurling a portion of the outer surface of the inner shell 20 near its mating end to form the rough portion 22.

In some exemplary embodiments, a method of manufacturing a receptacle connector for an electronic device may include providing an adhesive forming tool that is matched with the sealing member 40 in terms of a predetermined size and shape; placing a rough portion 22 of the mating end of the inner shell 20 to be processed in the adhesive forming tool, and applying an adhesive at the rough portion 22 in a circumferential direction of the inner shell 20. In some examples, the adhesive is applied in the adhesive forming tool by one of the following: time and pressure type dispensing, piston pump dispensing, and screw metering pump dispensing.

In some exemplary embodiments, an adhesive is received in the adhesive forming tool, and the adhesive may be selected from one of the following: UV adhesive, silicone, epoxy resin adhesive.

It should be understood that the method of manufacturing an electrical connector of the present application is not limited to the method described in the above specific embodiment, and that the individual steps described involve only a non-exhaustive list and do not have a specific order, and the order of the steps can be adjusted by one of ordinary skill in the art as needed.

Various aspects are described in this disclosure, which include, but are not limited to, the following aspects:

1. A receptacle connector (e.g., 1) for an electronic device, comprising: a terminal assembly (e.g., 30) comprising an insulative housing molded over a plurality of terminals molded; an inner shell (e.g., 20) configured to have a hollow cylindrical shape, the inner shell being sleeved on an outer side of the terminal assembly (e.g., 30); an outer shell (e.g., 10) attached to an outer side of the inner shell (e.g., 20) and the terminal assembly (e.g., 30), a mating end of the inner shell (e.g., 20) extending beyond a mating end of the outer shell (e.g., 10) in a mating direction (e.g., Y) in which the receptacle connector is connected with a corresponding plug connector; and a sealing member (e.g., 40) attached to a portion of an outer sidewall of the inner shell (e.g., 20) extending beyond the mating end of the outer shell (e.g., 10), characterized in that, the inner shell (e.g., 20) comprises a concave portion (e.g., 24) provided near a tail end of the inner shell (e.g., 20) and protruding toward an inner side of the inner shell (e.g., 20), and the concave portion (e.g., 24) is integrally formed with the inner shell (e.g., 20).

2. The receptacle connector according to aspect 1 or any other aspect, characterized in that the inner shell (e.g., 20) comprises a plurality of concave portions comprising a first concave portion (e.g., 241) and a second concave portion (e.g., 242) provided in pairs; the first concave portion (e.g., 241) is provided on a first sidewall (e.g., 21) of the inner shell (e.g., 20); the second concave portion (e.g., 242) is provided on a second sidewall (e.g., 23) of the inner shell (e.g., 20); the second sidewall (e.g., 23) is opposite to the first sidewall (e.g., 21) in a vertical direction (e.g., Z) perpendicular to a mating direction (e.g., Y); and the first concave portion (e.g., 241) and the second concave portion (e.g., 242) protrude toward each other in the vertical direction and are spaced apart from each other.

3. The receptacle connector according to aspect 2 or any other aspect, characterized in that the first concave portion (e.g., 241) is provided at a central portion of a tail end of the first sidewall (e.g., 21) in a horizontal direction (e.g., X) perpendicular to both the mating direction (e.g., Y) and the vertical direction (e.g., Z), the second concave portion (e.g., 242) is provided at a central portion of a tail end of the second sidewall (e.g., 23) in a horizontal direction (e.g., X), the first concave portion (e.g., 241) is formed with a concave portion recessed inward relative to an outer surface of the first sidewall, and the second concave portion (e.g., 242) is formed with a concave portion recessed inward relative to an outer surface of the second sidewall.

4. The receptacle connector according to aspect 2 or 3 or any other aspect, characterized in that the terminal assembly comprises an accommodating member (e.g., 31) provided in the vicinity of a tail end of an insulative housing; the accommodating member (e.g., 31) comprises a first accommodating portion (e.g., 311) configured to engage a first concave portion (e.g., 241) and a second accommodating portion (e.g., 312) configured to engage a second concave portion (e.g., 242); and the first accommodating portion (e.g., 311) and the second accommodating portion (e.g., 312) are provided on opposite sides of the accommodating member (e.g., 31) in the vertical direction (e.g., Z).

5. The receptacle connector according to any one of aspects 1 to 3 or any other aspect, characterized in that the inner shell (e.g., 20) comprises overhanging arms provided at a tail end of the inner shell (e.g., 20) and extending beyond the concave portion (e.g., 24) in a direction opposite to the mating direction (e.g., Y), and when the inner shell (e.g., 20) is assembled with the terminal assembly (e.g., 30), at least a portion of the overhanging arm extends in a direction toward an inner side of the inner shell (e.g., 20), in a tail end plane perpendicular to the mating direction (e.g., Y), and is engaged with a tail end surface of the insulative housing.

6. The receptacle connector according to aspect 5 or any other aspect, characterized in that the overhanging arms comprise at least a first set of overhanging arms (e.g., 261, 263) and a second set of overhanging arms (e.g., 265, 267); the first set of overhanging arms is provided adjacent to a third sidewall (e.g., 25) of the inner shell (e.g., 20) and the second set of overhanging arms is provided adjacent to a fourth sidewall (e.g., 27) of the inner shell (e.g., 20); the fourth sidewall (e.g., 27) is opposite to the third sidewall (e.g., 25) in a horizontal direction (e.g., X) perpendicular to the mating direction (e.g., Y); and the first set of overhanging arms and the second set of overhanging arms are disposed symmetrically about a vertical central axis (e.g., A) in a tail end plane of the inner shell (e.g., 20)

7. The receptacle connector according to aspect 6 or any other aspect, characterized in that each set of overhanging arms comprises a first overhanging arm and a second overhanging arm provided in pairs; the first overhanging arm comprises a first proximal end integrally connected with a tail end of the inner shell (e.g., 20) and a first distal end opposite to the first proximal end; the second overhanging arm comprises a second proximal end integrally connected with a tail end of the inner shell (e.g., 20) and a second distal end opposite to the second proximal end; and the first distal end of the first overhanging arm and the second distal end of the second overhanging arm extend toward a horizontal central axis (e.g., B) perpendicular to the vertical central axis (e.g., A) in the tail end plane of the inner shell (e.g., 20), when the inner shell (e.g., 20) is assembled with the terminal assembly (e.g., 30).

8. The receptacle connector according to aspect 7 or any other aspect, characterized in that the first distal end of the first overhanging arm and the second distal end of the second overhanging arm are disposed symmetrically about the horizontal central axis (e.g., B) when the inner shell (e.g., 20) is assembled with the terminal assembly (e.g., 30).

9. The receptacle connector according to any one of aspects 1 to 3 or any other aspect, characterized in that a protrusion (e.g., 28) is provided on an outer surface of the outer sidewall of the inner shell (e.g., 20), and the protrusion (e.g., 28) is configured to be spaced apart from the mating end of the inner shell (e.g., 20) by a predetermined distance, and is engaged with the mating end of the outer shell (e.g., 10).

10. The receptacle connector according to aspect 9 or any other aspect, characterized in that the protrusion (e.g., 28) is formed to have a circular cross-section, an oval cross-section, a triangular cross-section, a square cross-section, or an irregular shape cross-section.

11. The receptacle connector according to aspect 9 or any other aspect, characterized in that the protrusion (e.g., 28) is formed on an outer surface of a third sidewall (e.g., 25) and/or a fourth sidewall (e.g., 27) in the outer sidewall of the inner shell (e.g., 20), and the fourth sidewall (e.g., 27) is opposite to the third sidewall (e.g., 25) in a horizontal direction (e.g., X) perpendicular to the mating direction (e.g., Y).

12. The receptacle connector according to aspect 9 or any other aspect, characterized in that a mating end of the outer shell (e.g., 10) is provided with a concave fitting portion that is snap-fitted with the protrusion of the inner shell (e.g., 20).

13. The receptacle connector according to any one of aspects 1 to 3 or any other aspect, characterized in that a tail end of the inner shell (e.g., 20) is provided with an opening (e.g., 29) to allow at least a portion of the terminals of the terminal assembly (e.g., 30), that is connected with the printed circuit board of the electronic device, to be accessible.

14. The receptacle connector according to any one of aspects 1 to 3 or any other aspect, characterized in that a rough portion (e.g., 22) is provided on a portion of the outer sidewall of a mating end of the inner shell (e.g., 20) extending beyond a mating end of the outer shell (e.g., 10); and the sealing member (e.g., 40) is attached to the rough portion (e.g., 22) of the inner shell (e.g., 20), and the rough portion (e.g., 22) comprises a pattern formed by at least one of a diagonal pattern, a grid pattern, or a predetermined symbol pattern.

15. The receptacle connector according to aspect 14 or any other aspect, characterized in that the predetermined symbol pattern comprises at least one of a starlike shape, an H shape, or an X shape.

16. The receptacle connector according to aspect 14 or any other aspect,

characterized in that the rough portion (e.g., 22) has a width in a range of 0.1 mm to 5 mm from the proximal edge of the inner shell (e.g., 20) in the mating direction on the outer sidewall of the inner shell (e.g., 20).

17. The receptacle connector according to any one of aspects 1 to 3 or any other aspect, characterized in that the sealing member (e.g., 40) is an elastically deformable member and the sealing member (e.g., 40) is configured to elastically deform when the sealing member (e.g., 40) is in contact with the mounting portion of the electronic device, and to form an interference fit with the mounting portion of the electronic device in a direction perpendicular to the mating direction.

18. The receptacle connector according to any one of aspects 1 to 3 or any other aspect, characterized in that the sealing member (e.g., 40) is configured to have an annular shape extending circumferentially and continuously around the mating end of the inner shell (e.g., 20), and the sealing member (e.g., 40) is configured to have an attachment surface forming a positive fit with the mating end of the inner shell (e.g., 20).

19. The receptacle connector according to any one of aspects 1 to 3 or any other aspect, characterized in that the sealing member (e.g., 40) is provided with an angled portion (e.g., 41) at the mating end thereof along the mating direction, and an inclined outer surface of the angled portion (e.g., 41) forms an angle of 20 degrees to 40 degrees relative to the mating end surface of the sealing member.

20. A method of manufacturing a receptacle connector for an electronic device, comprising: providing a terminal assembly (e.g., 30) comprising an insulative housing molded over a plurality of terminals; providing an inner shell (e.g., 20) formed to have a hollow cylindrical shape; sleeving the inner shell (e.g., 20) on an outer side of the terminal assembly (e.g., 30), such that the inner shell (e.g., 20) covers at least a part of the terminal assembly (e.g., 30); providing an outer shell (e.g., 10); attaching the outer shell (e.g., 10) to an outer side of the inner shell (e.g., 20) and the terminal assembly (e.g., 30), such that a mating end of the inner shell (e.g., 20) extends beyond a mating end of the outer shell (e.g., 10) in a mating direction in which the receptacle connector is connected with a corresponding plug connector; and applying an adhesive along a circumferential direction of the inner shell (e.g., 20) at a portion of an outer sidewall of the mating end of the inner shell (e.g., 20) extending beyond the mating end of the outer shell (e.g., 10), and curing the adhesive to form a sealing member (e.g., 40) attached to the outer sidewall, characterized in that, the providing the inner shell comprises: providing a concave portion (e.g., 24) near a tail end of the inner shell (e.g., 20), and configuring the concave portion (e.g., 24) to protrude toward an inner side of the inner shell (e.g., 20), and to be integrally formed with the inner shell (e.g., 20).

21. The method of manufacturing a receptacle connector for an electronic device according to aspect 20 or any other aspect, characterized in that the providing the inner shell comprises: providing in the inner shell (e.g., 20) a plurality of concave portions, and configuring the plurality of concave portions to comprise a first concave portion (e.g., 241) and a second concave portion (e.g., 242) provided in pairs; wherein the first concave portion (e.g., 241) is provided on a first sidewall (e.g., 21) of the inner shell (e.g., 20); the second concave portion (e.g., 242) is provided on a second sidewall (e.g., 23) of the inner shell (e.g., 20); the second sidewall (e.g., 23) is opposite to the first sidewall (e.g., 21) in a vertical direction (e.g., Z) perpendicular to a mating direction (e.g., Y); and the first concave portion (e.g., 241) and the second concave portion (e.g., 242) protrude toward each other in the vertical direction and are spaced apart from each other.

22. The method of manufacturing a receptacle connector for an electronic device according to aspect 20 or any other aspect, characterized in that the providing the inner shell comprises: providing at a tail end of the inner shell (e.g., 20) a plurality of overhanging arms, and configuring the overhanging arms to extend beyond the concave portion (e.g., 24) in a direction opposite to the mating direction; wherein the overhanging arms are configured to extend at least partially along a distal circumferential portion of the outer sidewall of the inner shell (e.g., 20) when the inner shell (e.g., 20) is not assembled with the terminal assembly (e.g., 30), and the overhanging arms are configured to at least partially in a direction toward an inner side of the inner shell (e.g., 20), and is engaged with a tail end surface of the insulative housing when the inner shell (e.g., 20) is assembled with the terminal assembly (e.g., 30).

23. The method of manufacturing a receptacle connector for an electronic device according to any one of aspects 20 to 22 or any other aspect, characterized in that the providing the inner shell comprises: roughening a portion of an outer surface of the inner shell (e.g., 20) near its mating end by laser engraving processing or electrical discharge processing to form a rough portion (e.g., 22); or embossing or knurling a portion of the outer surface of the inner shell near its mating end to form the rough portion (e.g., 22).

24. The method of manufacturing a receptacle connector for an electronic device according to aspect 23 or any other aspect, characterized in that the method comprises: providing an adhesive forming tool that is matched with the sealing member in terms of a predetermined size and shape; placing the rough portion (e.g., 22) of the mating end of the inner shell to be processed in the adhesive forming tool, and applying an adhesive at the rough portion in a circumferential direction along the inner shell, wherein the adhesive is applied in the adhesive forming tool by one of the following: time and pressure type dispensing, piston pump dispensing, and screw metering pump dispensing.

25. The method of manufacturing a receptacle connector for an electronic device according to any one of aspects 20 to 22 or any other aspect, characterized in that the providing the inner shell comprises: providing a protrusion (e.g., 28) on an outer surface of the outer sidewall of the inner shell (e.g., 20), and configuring the protrusion (e.g., 28) to be spaced apart from the mating end of the inner shell (e.g., 20) by a predetermined distance.

26. A receptacle connector (e.g., 1) may include a shell (e.g., 20) surrounding a cavity (e.g., 104) and a terminal assembly (e.g., 30) disposed in the cavity. The shell may include a mating end (e.g., 106), and a tail end (e.g., 108) opposite the mating end and comprising a portion (e.g., 24) protruding into the cavity. The terminal assembly may include a housing comprising a body (e.g., 114) engaging the body of the shell and a tongue (e.g., 116) extending from the body in a mating direction (e.g., Y); and a plurality of terminals held by the housing, each of the plurality of terminals comprising a mating portion (e.g., 120) held by the tongue, a tail portion (e.g., 128) extending out of the housing, and an intermediate portion held in the body.

27. The receptacle connector of aspect 26 or any other aspect, wherein the portion of the tail end of the shell protruding into the cavity comprises a first subportion (e.g., 702) extending perpendicular to the mating direction; and a second subportion (e.g., 704) extending parallel to the mating direction so as to engage the body of the housing of the terminal assembly.

28. The receptacle connector of claim 27 or any other aspect, wherein the portion of the tail end of the shell protruding into the cavity comprises a third subportion (e.g., 706) extending in an obtuse angle to the mating direction.

29. The receptacle connector of claim 26 or any other aspect, wherein the body of the housing of the terminal assembly comprises a recessed portion (e.g., 311); and the portion of the tail end of the shell protrudes into the recessed portion of the body of the housing of the terminal assembly to engage the body of the housing.

30. The receptacle connector of claim 26 or any other aspect, wherein the tail end of the shell comprises an arm (e.g., 261, 263, 265, or 267) disposed beyond the housing of the terminal assembly and extend into the cavity so as to abut against a rear surface of the terminal assembly.

31. The receptacle connector of claim 26 or any other aspect, wherein the tail end of the shell comprises a first portion (e.g., 241) protrudes into the cavity from an upper wall (e.g., 21) of the shell; and the shell comprises a second portion (e.g., 242) protrudes into the cavity from a bottom wall (e.g., 23) of the shell, the bottom wall facing the upper wall.

32. The receptacle connector of claim 26 or any other aspect, wherein the tail end of the shell comprises a plurality of arms disposed beyond the housing of the terminal assembly and engaging a rear surface of the terminal assembly; and the plurality of arms are disposed in symmetrical pairs.

33. The receptacle connector of claim 26 or any other aspect, wherein the mating end of the shell comprises a portion (e.g., 22) that has a surface roughness higher than that of portions of the shell; and the receptacle connector comprises a sealing member (e.g., 40) attached to the portion of the mating end of the shell.

34. The receptacle connector of claim 33 or any other aspect, wherein the portion that has the higher surface roughness extends in the mating direction by a distance in a range of 0.1 mm to 5 mm.

35. The receptacle connector of claim 33 or any other aspect, wherein the mating end of the shell comprises a flange portion (e.g., 302) extending around the shell to form a corner portion (e.g., 1102) with the portion that has the higher surface roughness; and the scaling member is disposed at the corner portion.

36. The receptacle connector of claim 26 or any other aspect, wherein for each of the plurality of terminals, the tail portion comprises a surface (e.g., 126) extending perpendicular to the mating direction and configured to mount to a surface of a circuit board.

37. The receptacle connector of claim 36 or any other aspect, wherein the shell is a first shell (e.g., 20); the receptacle connector comprises a second shell (e.g., 10) disposed outside of the first shell; the second shell comprises a mating end (e.g., 110) and a tail end (e.g., 112) opposite the mating end and comprising a plurality of legs (e.g., 122) extending beyond the tail portions of the plurality of terminals and configured to insert into holes of a circuit board (e.g., 1202); and the mating end of the first shell extend beyond a mating end of the second shell.

38. The receptacle connector of claim 26 or any other aspect, wherein the shell comprises a dent (e.g., 126) disposed closer to the mating end than the portion of the tail end; and the portion of the tail end protrude into the cavity deeper than the dent.

39. A receptacle connector may include a terminal assembly (e.g., 30) comprising a housing comprising a body and a tongue extending from the body in a mating direction, and a plurality of terminals held by the housing, each of the plurality of terminals comprising a mating portion held by the tongue, a tail portion extending out of the housing, and an intermediate portion held in the body; an inner shell (e.g., 20) enclosing the housing of terminal assembly in a cavity; and an outer shell (e.g., 10) enclosing a portion of the inner shell. The tail portions of the plurality of terminals may extend out of the cavity of the inner shell. A mating end of the inner shell may extend beyond a mating end of the outer shell. A tail end of the outer shell may comprise a pair of transition portions (e.g., 124) extending from a side wall and jogging away from each other and an opening (e.g., 102) between the pair of transition portions. The tail end (e.g., 108) of the inner shell may be at least partially exposed by the opening between the pair of transition portions of the outer shell.

40. The receptacle connector of claim 39 or any other aspect, wherein the tail end of the inner shell comprises a portion (e.g., 24) protruding into the cavity and engaging a recessed portion of the body of the housing of the terminal assembly.

41. The receptacle connector of claim 40 or any other aspect, wherein the tail end of the inner shell comprises a plurality of arms (e.g., 261, 263, 265, and/or 267) disposed beyond the housing of the terminal assembly and engaging a rear surface of the terminal assembly.

42. The receptacle connector of claim 41 or any other aspect, wherein the tail portion of each of the plurality of terminals comprises a surface (e.g., 126) extending perpendicular to the mating direction (e.g., Y) and configured to mount to a surface of a circuit board; and each of the pair of transition portions of the outer shell has a leg (e.g., 122) extending therefrom in a direction opposite to the mating direction and configured to mount into a hole of the circuit board.

43. The receptacle connector of claim 42 or any other aspect, wherein the inner shell comprises a protrusion (e.g., 28) engaging the mating end (e.g., 110) of the outer shell so as to restrain movement of the outer shell in the mating direction.

44. A method of manufacturing a receptacle connector (e.g., 1). The method may include providing a shell (e.g., 20) surrounding a cavity, the shell having a first end (e.g., 106) and a second end (e.g., 108) opposite the second end; providing a terminal assembly (e.g., 30) comprising a housing having a body (e.g., 114) and a tongue (e.g., 116) extending from the body in a first direction, the body comprising a recessed portion (e.g., 311);

disposing the terminal assembly into the cavity of the shell; and protruding a portion (e.g., 24) of the second end of the shell into the cavity (e.g., 104) before or after disposing the terminal assembly such that the portion of the second end of the shell is disposed in the recessed portion of the body of the terminal assembly.

45. The method of claim 44 or any other aspect, wherein the shell is a first shell (e.g., 20) comprising a plurality of arms disposed beyond the body of the housing of the terminal assembly, and a protrusion (e.g., 28) extending outwards. The method may comprise bending the plurality of arms such that the plurality of arms abut against a rear surface of the terminal assembly; providing a second shell (e.g., 10) comprising a mating end and a tail end having a plurality of legs; and sleeving the second shell onto the first shell until the mating end of the second shell engaging the protrusion of the first shell.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within ±3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector comprising:
a shell surrounding a cavity, the shell comprising:
a mating end, and
a tail end opposite the mating end and comprising a portion protruding into the cavity; and
a terminal assembly disposed in the cavity, the terminal assembly comprising:
a housing comprising a body engaging the body of the shell and a tongue extending from the body in a mating direction; and
a plurality of terminals held by the housing, each of the plurality of terminals comprising a mating portion held by the tongue, a tail portion extending out of the housing, and an intermediate portion held in the body.

2. The receptacle connector of claim 1, wherein the portion of the tail end of the shell protruding into the cavity comprises:
a first subportion extending perpendicular to the mating direction; and
a second subportion extending parallel to the mating direction so as to engage the body of the housing of the terminal assembly.

3. The receptacle connector of claim 2, wherein the portion of the tail end of the shell protruding into the cavity comprises:
a third subportion extending in an obtuse angle to the mating direction.

4. The receptacle connector of claim 1, wherein:
the body of the housing of the terminal assembly comprises a recessed portion; and
the portion of the tail end of the shell protrudes into the recessed portion of the body of the housing of the terminal assembly to engage the body of the housing.

5. The receptacle connector of claim 1, wherein:
the tail end of the shell comprises an arm disposed beyond the housing of the terminal assembly and extend into the cavity so as to abut against a rear surface of the terminal assembly.

6. The receptacle connector of claim 1, wherein the tail end of the shell comprises:
a first portion protrudes into the cavity from an upper wall of the shell; and
the shell comprises a second portion protrudes into the cavity from a bottom wall of the shell, the bottom wall facing the upper wall.

7. The receptacle connector of claim 1, wherein:
the tail end of the shell comprises a plurality of arms disposed beyond the housing of the terminal assembly and engaging a rear surface of the terminal assembly; and
the plurality of arms are disposed in symmetrical pairs.

8. The receptacle connector of claim 1, wherein:
the mating end of the shell comprises a portion that has a surface roughness higher than that of portions of the shell; and
the receptacle connector comprises a sealing member attached to the portion of the mating end of the shell.

9. The receptacle connector of claim 8, wherein:
the portion that has the higher surface roughness extends in the mating direction by a distance in a range of 0.1 mm to 5 mm.

10. The receptacle connector of claim 8, wherein:
the mating end of the shell comprises a flange portion extending around the shell to form a corner portion with the portion that has the higher surface roughness; and
the sealing member is disposed at the corner portion.

11. The receptacle connector of claim 1, wherein, for each of the plurality of terminals:
the tail portion comprises a surface extending perpendicular to the mating direction and configured to mount to a surface of a circuit board.

12. The receptacle connector of claim 11, wherein:
the shell is a first shell;
the receptacle connector comprises a second shell disposed outside of the first shell;
the second shell comprises a mating end and a tail end opposite the mating end and comprising a plurality of legs extending beyond the tail portions of the plurality of terminals and configured to insert into holes of a circuit board; and
the mating end of the first shell extend beyond a mating end of the second shell.

13. The receptacle connector of claim 1, wherein:
the shell comprises a dent disposed closer to the mating end than the portion of the tail end; and
the portion of the tail end protrude into the cavity deeper than the dent.

14. A receptacle connector comprising:
a terminal assembly comprising:
a housing comprising a body and a tongue extending from the body in a mating direction; and
a plurality of terminals held by the housing, each of the plurality of terminals comprising a mating portion held by the tongue, a tail portion extending out of the housing, and an intermediate portion held in the body;
an inner shell enclosing the housing of terminal assembly in a cavity; and
an outer shell enclosing a portion of the inner shell, wherein:
the tail portions of the plurality of terminals extend out of the cavity of the inner shell;
a mating end of the inner shell extends beyond a mating end of the outer shell;
a tail end of the outer shell comprises a pair of transition portions extending from a side wall and jogging away from each other and an opening between the pair of transition portions; and
the tail end of the inner shell is at least partially exposed by the opening between the pair of transition portions of the outer shell.

15. The receptacle connector of claim 14, wherein:
the tail end of the inner shell comprises a portion protruding into the cavity and engaging a recessed portion of the body of the housing of the terminal assembly.

16. The receptacle connector of claim 15, wherein:
the tail end of the inner shell comprises a plurality of arms disposed beyond the housing of the terminal assembly and engaging a rear surface of the terminal assembly.

17. The receptacle connector of claim 16, wherein:
the tail portion of each of the plurality of terminals comprises a surface extending perpendicular to the mating direction and configured to mount to a surface of a circuit board; and
each of the pair of transition portions of the outer shell has a leg extending therefrom in a direction opposite to the mating direction and configured to mount into a hole of the circuit board.

18. The receptacle connector of claim 17, wherein:
the inner shell comprises a protrusion engaging the mating end of the outer shell so as to restrain movement of the outer shell in the mating direction.

19. A method of manufacturing a receptacle connector, the method comprising:
providing a shell surrounding a cavity, the shell having a first end and a second end opposite the second end;
providing a terminal assembly comprising a housing having a body and a tongue extending from the body in a first direction, the body comprising a recessed portion;
disposing the terminal assembly into the cavity of the shell; and
protruding a portion of the second end of the shell into the cavity before or after disposing the terminal assembly such that the portion of the second end of the shell is disposed in the recessed portion of the body of the terminal assembly.

20. The method of claim 19, wherein:
the shell is a first shell comprising a plurality of arms disposed beyond the body of the housing of the terminal assembly, and a protrusion extending outwards;
the method comprises:
bending the plurality of arms such that the plurality of arms abut against a rear surface of the terminal assembly;
providing a second shell comprising a mating end and a tail end having a plurality of legs; and
sleeving the second shell onto the first shell until the mating end of the second shell engaging the protrusion of the first shell.
